(19) United States
(12) Patent Application Publication
(10) Pub. No.: US 2014/0081731 A1
(43) Pub. Date: Mar. 20, 2014

(54) NON INTRUSIVE SYSTEM & METHOD FOR REAL TIME TRANSACTIONAL DATA CAPTURE

(71) Applicants: Anant Damodar Mahale, Pune (IN); Unmesh Shrikant Mayekar, Pune (IN)

(72) Inventors: Anant Damodar Mahale, Pune (IN); Unmesh Shrikant Mayekar, Pune (IN)

(21) Appl. No.: 14/115,102

(22) PCT Filed: Apr. 18, 2012
(86) PCT No.: PCT/IN2012/000277

§ 371 Date: Nov. 1, 2013

(30) Foreign Application Priority Data
May 18, 2011 (IN) 1505/MUM/2011

(51) Int. Cl. G06Q 30/02

(52) U.S. Cl. CPC G06Q 30/0233; G06Q 30/0222
USPC 705/14.23

(57) ABSTRACT

The invention described here relates to an automated system and method to extract selective information from a store receipt and/or to insert selective information into a store receipt in real time without altering the existing store level transaction processing system and process. Since data capture and insertion can be accomplished without replacing or interfering with the existing systems in the store, this technology serves as the foundation to deliver all of the above capabilities within a single solution. Further, it allows retailers to gain revenue by offering space on their receipts to print customized advertisements for other businesses.

### RELATED APPLICATION

This application claims priority from Indian patent application number (CBR NO: 5999-1505/MUM/2011) filed on 18 May 2011 (18 May 2011) 12:42:09 titled “ Non intrusive system a method for real time transactional data capture” the contents of which are herein incorporated in entirety.

### FIELD OF INVENTION

Embodiment of this invention related to an automated system and method to extract selective information from a store receipt and/or to insert selective information into a store receipt in real time without altering the existing store level transaction processing system and process and use it to deliver an end to end closed loop store performance a shopper relationship management solution aimed at improving store revenue a shopper satisfaction

### BACKGROUND

Small and mid size enterprise (SME) Retailers today are also in need of technology based solutions to not just manage and operate their stores, but to gain store-level insights on product sales, customer preferences and supplier performance. In addition they need technology to use this insight to design and execute personalized customer loyalty programs a campaigns to improve first time and repeat business and to execute supplier collaboration processes to improve timely fulfillment and inventory management.

### SUMMARY

While Independent stand alone solutions exist for handling each of the above needs, (e.g.—In-store transaction processing, Loyalty points management, Consumer spend data analytics, Promotions management, Store level assortment Et inventory planning, Supplier collaboration) the value gained by a Retailer is limited because these solutions work independent of each other.

Building a system that simply integrates all of these independent solutions results in a customized solution per store and therefore becomes cost prohibitive and difficult to maintain because of the large number Et variety of solutions that are in use today within each of these categories. Further, most SME retailers prefer not to replace their existing solution components with an entirely new solution.

The invention described here relates to an automated system and method to extract selective information from a store receipt and/or to insert selective information into a store receipt in real time without altering the existing store level transaction processing system and process. Since data capture and insertion can be accomplished without replacing or interfering with the existing systems in the store, this technology serves as the foundation to deliver all of the above capabilities within a single solution. Further, it allows retailers to gain revenue by offering space on their receipts to print customized advertisements for other businesses.

The invention is related to a system and method for performing in real time for an entity without any interference or change to an existing setup at the entity at least one of extracting selective information from an object; and/or inserting selective incremental information into the object. The information is transmitted over at least one of a wired or wireless network. The entity includes a facility involving printing of information. The information is transmitted instantly to the entity on availability of connectivity. Further on non-availability of connectivity, the information is stored in a host, and on determination of available connectivity, transmitting the information stored in the host to the entity.

The invention further includes performing data analytics on the information in real time; and providing a user a real time view of the analytics of the information including customer buying preferences, products, product categories, specific sales volumes, sales revenues, impact of promotional campaigns over any selected time period. The information in one embodiment is transmitted to a user using push or pull technology. In a further embodiment a loyalty program can be executed for the entity. In yet a further embodiment a device with an attached bar code scanner captures the transactions.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description. The above as well as additional objectives, features, and advantages of the present invention will become apparent in the following detailed written description.

### BRIEF DESCRIPTION OF THE DRAWINGS

The description of the illustrative embodiments is to be read in conjunction with the accompanying drawings, wherein

FIG. 1 illustrates an exemplary embodiment of a data processing system or computer system on which the invention may be implemented or used;

FIG. 2 illustrates an exemplary embodiment of a method 200 in accordance with the present invention.

FIG. 3 illustrates an exemplary embodiment of a method 300 in accordance with the present invention.

FIG. 4 illustrates various scenarios 400 of a customer receiving redemption codes.

FIG. 5 illustrates an exemplary embodiment of a method 500 in accordance with the present invention.

### DETAILED DESCRIPTION

As will be appreciated by a person skilled in the art, embodiments of the invention may be embodied as a system, method or computer program product. Accordingly, embodiments of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments of the invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium, upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the invention provide a method, system and computer program product for purging inactive objects from an entity thereby reducing the size of the entity by producing a thinner entity. In one embodiment, the custom inactive objects are identified in a specified entity the identified custom inactive objects are purged from the specified entity. Once the inactive objects are purged, a report is generated dynamically identifying all the purged inactive objects.

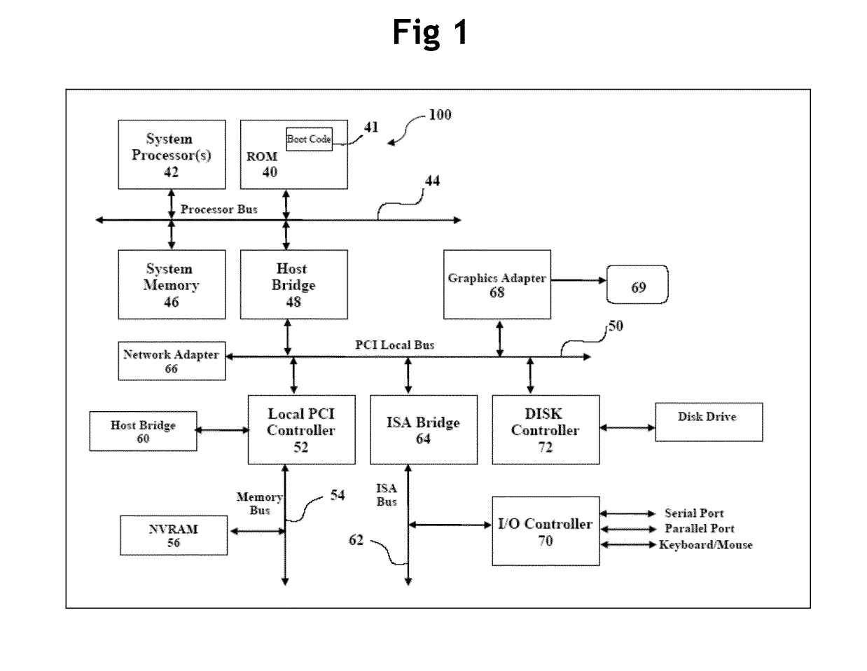

Reference is now made to FIG. 1, which depicts a block diagram of an exemplary embodiment of computer system 100 (any data processing system consisting at least a processor and a memory, capable of processing information/data). The exemplary computer system depicted in FIG. 1 in one embodiment consists of a device having at least a processor and a memory, and for example covers electronic devices such as a laptop or desktop personal computer, a mobile/smart phone, PDAs or the like. As is apparent from the description, however that embodiments of the invention may be implemented in any appropriately configured device, as described herein.

As illustrated in FIG. 1, computer system 100 includes at least one system processor 42, which is coupled to a Read-Only Memory (ROM) 40 and a system memory 46 by a bus 44, preferably a processor bus. System processor 42, may include at least one of the AMD line of processors produced by AMD Corporation or a processor produced by INTEL Corporation or a processor produced by International Business Machines Corporation, such as a POWER processor, and is typically a general-purpose processor that executes boot code 41 stored within ROM 40 at power-on and thereafter processes data under the control of an operating system (not explicitly shown in the figure) and application software (not explicitly shown in the figure) stored in system memory 46. System processor 42 is coupled via bus 44 and host bridge 48 to Peripheral Component Interconnect (PCI) local bus 50.

PCI local bus 50 supports the attachment of a number of devices, including adapters and bridges. Among these devices is network adapter 66, which interfaces computer system 100 to LAN, and graphics adapter 68, which interfaces computer system 100 to display 69. Communication on PCI local bus 50 is governed by local PCI controller 52, which is in turn coupled to non-volatile random access memory (NVRAM) 56 via memory bus 54. Local PCI controller 52 can be coupled to additional buses and devices via a second host bridge 60.

Computer system 100 further includes Industry Standard Architecture (ISA) bus 62, which is coupled to PCI local bus 50 by ISA bridge 64. Coupled to ISA bus 62 is an input/output (I/O) controller 70, which controls communication between computer system 100 and attached peripheral devices such as a as a keyboard, mouse, serial and parallel ports, et cetera. A disk controller 72 connects a disk drive with PCI local bus 50. The USB Bus and USB Controller (not explicitly shown in the figure) are part of the Local PCI controller 52.

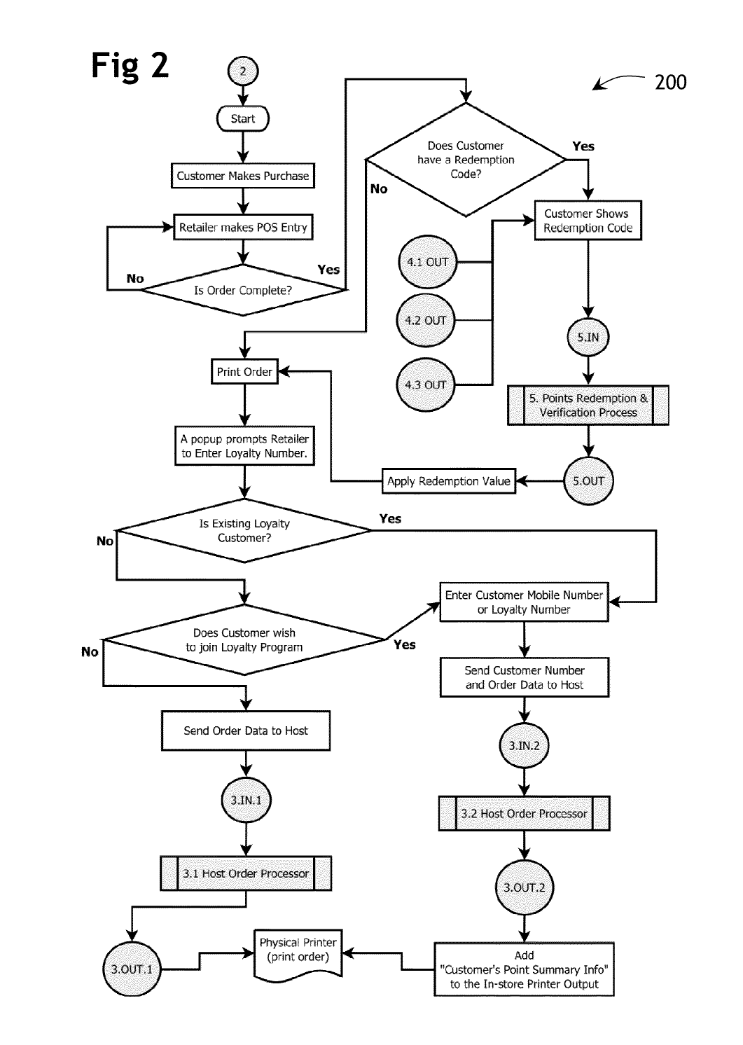

FIG. 2 illustrates an exemplary embodiment of a method 200 in accordance with the present invention. The customer (hereinafter also referred to as a user or client) makes a purchase at an entity (hereinafter also referred to as a organization or store or retail or the likes). On a purchase being made, the retail makes a point of sales (POS) entry. Subsequently a check is made to determine if the sale is complete or not, if the sale is incomplete, then until the sale is complete, the POS entry is updated. Once the POS entry is complete, a check is made to determine if the customer has any redemption code. If the customer does not have a redemption code, then the customer may be prompted to register with such a service so that the points collected may be added to a loyalty program of the customer. If the customer does not have any redemption coupons/code, then the order is printed.

However, if the customer has a redemption code then the customer is prompted to provide the redemption code to the store. The points accumulated are requested to be redeemed as required and the process is verified by the store and the store then applies the redemption value of the available to the customer and then the order is printed.

Once the order is printed, in one embodiment the loyalty number needs to be provided by the retailer. A check is made to see if the customer is under any loyalty program. If the customer is not registered, then the customer may be registered under a loyalty program or if the customer wishes to join the loyalty program. If at this state the answer is NO, then the order data is transmitted to the host and the host processes the order. The host is for example a data processing system shown in FIG. 1. Once the order is processed, the order is printed for the customer.

Alternatively, if the customer exists under a loyalty program, then the customer provides some identification number, for example a mobile number or a loyalty number, the identification number along with the order is sent to a processing host to be processed accordingly by applying the redemption and the final order is printed for the customer.

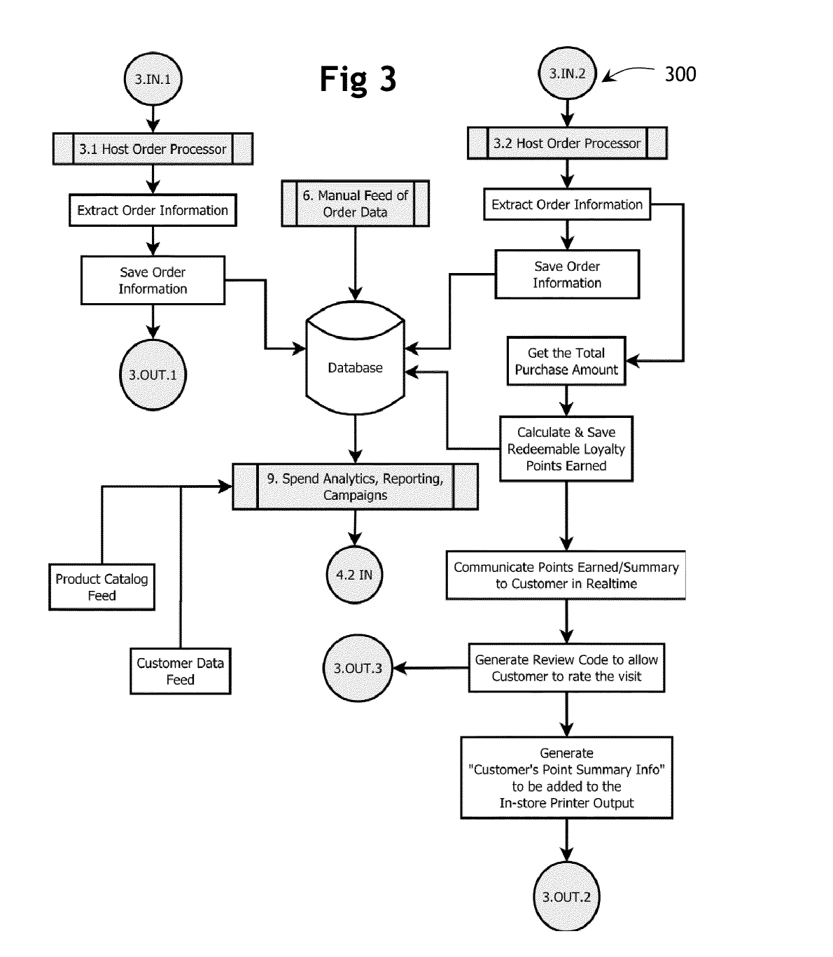

FIG. 3 illustrates an exemplary embodiment of a method 300 in accordance with the present invention. In accordance with an embodiment of the invention the host processing system has a host order processor, is configured to extract the order information and save the order information in database. In another embodiment, the order data can be manually fed into the database.

In another embodiment, instead of saving the order information in the database, the total amount of purchase by the customer is determined. Loyalty points can be computed and saved in the database, if the customer is not redeeming the points and a communication can be sent to customer on the points earned during the purchase, which includes a summary of information as determined by the customer or the service provider.

From the product catalogue and customer data taken as input along with the data available from the database various analytics related to business can be preformed, such as spent analytics, reporting to the customer and the entity etc.

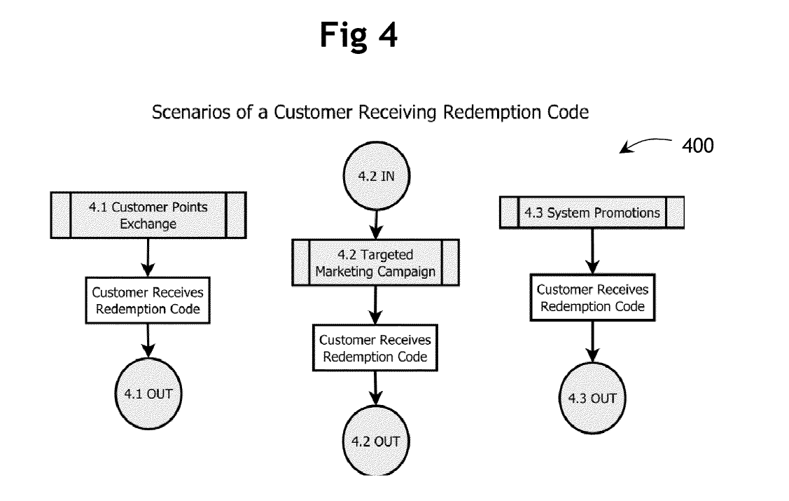

FIG. 4 illustrates various scenarios 400 of a customer receiving redemption codes. In a first scenario, when the customer exchanges the points earned, then the customer is provided with a redemption code/coupon which is unique to the customer and based on the amount of points that the customer wants to redeem.

In another scenario, in a targeted marketing campaign for a particular product, the entity may provide the customer with certain number of loyalty points that can be provided to the customer as a redemption code/coupon, again which is unique to a customer and the customer may redeem the coupon issued, which can be used to be redeemed against the targeted marketing products in consideration.

In yet another scenario, system promotion may be possible and under such circumstances, the customer can again be provided with redemption code/coupon which can be used by the customer to be redeemed against the system promotions.

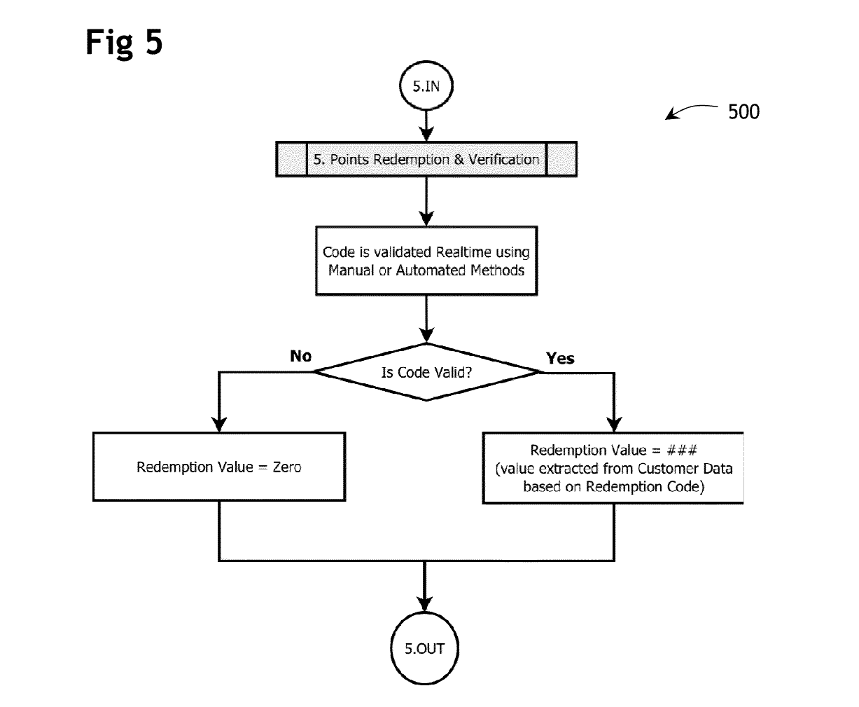

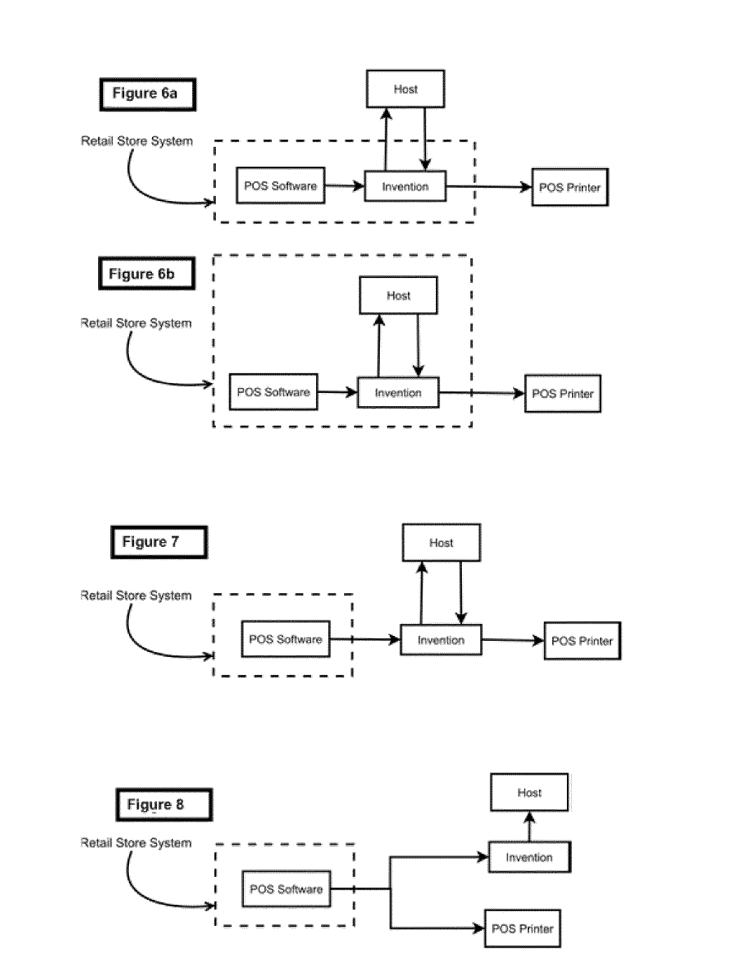

FIG. 5 illustrates an exemplary embodiment of a method 500 in accordance with the present invention, where points redemption and verification is considered. The redemption coupon is validated in real time or by a manual process or any other automated process. A check is made to determine if the redemption code is a valid one or not, if not the redemption value is set to be zero. If the redemption code is valid, then the redemption value is extracted from the customer data available in the database, based on the redemption code.

### End to End Workflow:

The workflow described here starts with a shopper walking into a store to make a purchase. As soon as a shopper walks into the store and makes a purchase and is ready to check out, the cashier logs in the order into the store Point of Sale system (POS). At this time if the shopper already has a redemption code that can be applied towards these purchases, the shopper is requested to show the code.

There are various ways in which a redemption code is generated and provided to the shopper. The code is communicated to the shopper through a member's only website and via a message on his Mobile phone and/or email. The shopper can review his loyalty point's status on an as needed basis and request for a redemption code for all or part of his accumulated points. The cashier enters this code into the system and requests the system for validation.

The system performs a real time validation check and responds prompting the cashier to accept or reject the code. (In case the system is down, a manual validation process is carried out). In case the code is not valid, the cashier has to inform the shopper and request for a different code and repeat the process or move forward with completion of the order without incorporating the redemption code. As soon as the order is completed and the cashier gives the command to print the receipt, a popup window appears on the interface that requires the cashier to enter the loyalty number or the mobile number of the shopper. In case the shopper is already a loyalty member, this number is entered. In case the shopper is not already a member but wishes to become a member, the mobile number of the shopper is entered. In case the shopper does not wish to become a member, the cashier moves forward with closing the transaction.

In all three scenarios, the shopper order data including item level detail is sent to the Host along with the shopper loyalty number (if entered) or mobile number (if entered). The Host captures and archives this data for future use. The Host receives this data, extracts the order information and saves the data in a database. In case the data is accompanied with a loyalty number of an existing shopper, the Host calculates the latest status of redeemable points for that shopper and sends a message to the shopper in real time on his mobile number. This message can be customized for the specific shopper based upon his loyalty status for the specific store, and his historical spend profile. Alternately, in case of a new loyalty member, the server initiates a new account, assigns a new loyalty number to the shopper, calculates the redeemable loyalty points accumulated from the purchase, and sends a message welcoming the new loyalty member. This message can be customized based upon store request. The Host generates a review code that is included in the real time message to the shopper asking him to rate the visit.

The Host sends out the shopper's points summary to the store printer. This is printed at the end of the receipt. In addition to receiving real time order data at the time of the transaction, the server has the ability to take in batch uploads as well as manual uploads of store order and shopper data. This capability is useful in case the store level systems are down for a temporary period of time due to emergency. The Host has a data analytics engine that generates real time charts to provide the retailer with insight into the health of his store (business) including but not limited to - revenue, shopper traffic, Cardless Loyalty Program status, shopper level loyalty index, product level sales volume, etc. These dashboards are updated in real time using store level order and shopper data and can be used by the retailer to develop and execute strategies to reach out to new and existing shoppers with focused customized campaigns that promote items of their preference. The product based sales volume allows a retailer to develop and execute product assortment and pricing strategies to improve their top line.

The data analytics engine also generates real time charts to provide the shopper with insight into their spend including but not limited to—their spend by items, the loyalty points accumulated by store, redemption status, opportunities to redeem points, discounts and special offers available at any time especially in categories of their shopping interest in their locality. Note—The Host mentioned in the description above, can be either located within the same store or at a separate remote location.

### Configuration:

The primary components that work together in the end to end workflow which has been described above are:
The Retail store transaction system (also referred to as—Point of Sale (POS) system)
The system described in this invention (also referred to as—Invention)
The Host
The Retail store POS printer (also referred to as—POS printer)

There are two distinct embodiments of the invention:
Embodiment 1—Exclusively as a software system—without any hardware component—a configuration in which the invention is exclusively implemented in software. As shown in the FIG. 6a, the software receives data from the Retail Store POS system, as it gets sent out for printing to the Store POS printer. Predetermined useful data is extracted by the invention and sent to the Host for processing. Processed data is received from the Host by the invention and then sent out to the Store POS printer to execute the print command. The configuration shown in FIG. 6b functions the same as the configuration shown in FIG. 6a with the exception that it is implemented with the Host sharing the same infrastructure with the Retail store transactional system.
Embodiment 2—As a hybrid system that includes a software and a hardware component—a configuration in which the invention is implemented in a hybrid form that includes a software and a hardware component. As shown in FIG. 7, the invention which is resident on its own specific hardware, is connected to the Retail Store POS system infrastructure. Data flows from the Retail store POS system to the invention and through that gets sent to the Store POS printer. In the process, the invention extracts the useful data and sends it to the Host for processing and storage. Incremental data could also be entered directly into the invention using the user interface provided.
A variation of Embodiment 2 could be as shown in FIG. 8; where the same data is sent from the Retail store POS system, simultaneously to the invention as well as to the store POS printer. Data that is received by the invention is then transferred to the Host for processing and storage. In this embodiment, the invention is used only to capture a archive store level data. This configuration allows the POS printer to function independently without any interception from the invention.
A further embodiment comprises a hardware device, for example portable electronic devices such as mobile phone or android pads, which is connected to a local area network (LAN) or a wide area network (WAN), or the connection may be made to an external computer, for example, through the Internet using an Internet Service Provider, and the portable electronic devices has an inbuilt camera or attached scanner to scan bar-codes. The device is provided to a store worker who uses the same to scan in, archive and transmit store level item data without the need to print. This data is used for analytics and stock management.

Thus, it is important that while an illustrative embodiment of the present invention is described in the context of a fully functional computer (server) system with installed (or executed) software, those skilled in the art will appreciate that the software aspects of an illustrative embodiment of the present invention are capable of being distributed as a program product in a variety of forms, and that an illustrative embodiment of the present invention applies equally regardless of the particular type of media used to actually carry out the distribution.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof. Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

We claim:

1. A method comprising
performing in real time for an entity without interference or change to an existing setup of the entity at least one of
extracting selective information from an object; and/or
inserting selective incremental information into the object.

2. The method as claimed in claim 1, wherein the information is transmitted over at least one of a wired or wireless network.

3. The method as claimed in claim 1, wherein the entity includes a facility for printing of information.

4. The method as claimed in claim 1, wherein the information is transmitted instantly to the entity.

5. The method as claimed in claim 1, wherein on non-availability of connectivity to the entity, the information is stored in a host, and on determination of available connectivity by the host, transmitting the information stored in the host to the entity.

6. The method as claimed in claim 1, further comprises
performing data analytics on the information in real time; and
providing a user a real time view of the analytics of the information including customer buying preferences, products, product categories, specific sales volumes, sales revenues, impact of promotional campaigns over any selected time period.

7. The method of claim 6, wherein the information is transmitted to a user using a push mechanism or a pull mechanism.

8. The method of claim 7, wherein a loyalty program can be executed for the user by the entity.

9. The method of claim 1 wherein for any device with an attached bar code a scanner captures the transactions.

10. A system configured to perform the method as claimed in any of the preceding method claims 1 to 9.
